(19) United States
(12) Patent Application Publication
(10) Pub. No.: US 2015/0035979 A1
(43) Pub. Date: Feb. 5, 2015

(54) METHOD FOR DERIVING ENVIRONMENTAL INFORMATION FROM DETECTING THE REAR LIGHTS OF PRECEDING VEHICLES

(71) Applicants: Marc Fischer, Nonnenhorn (DE); Dirk Ulbricht, Wangen (DE)

(72) Inventors: Marc Fischer, Nonnenhorn (DE); Dirk Ulbricht, Wangen (DE)

(73) Assignee: Conti Temic Microelectronic GmbH, Nürnberg (DE)

(21) Appl. No.: 14/118,580

(22) PCT Filed: May 8, 2012
(86) PCT No.: PCT/DE12/00130

§ 371 Date: Feb. 7, 2014

(30) Foreign Application Priority Data
May 26, 2011 (DE) 10 2011 102 512.3

(51) Int. Cl. G06K 9/00; H04N 7/18; G06T 7/00; G01J 1/42

(52) U.S. Cl. CPC G06K 9/00825; G01J 1/42; H04N 7/183; G06T 7/004; G06T 2207/10016; G06T 2207/30252
USPC 348/148

(57) ABSTRACT

A method for deriving environmental information from detecting the rear lights of preceding vehicles, including the following steps: Recording a sequence of images with a camera that captures the surroundings in front of the vehicle; Detecting and tracking rear lights of preceding vehicles in the sequence of images; and Analysis of the position and movement of the tracked rear lights and deriving environmental information from this analysis.

### CROSS REFERENCE TO RELATED APPLICATIONS

This application is the U.S. National Phase Application of PCT/DE2012/100130, filed May 8, 2012, which claims priority to German Patent Application No. 10 2011 102 512.3, filed May 26, 2011, the contents of such applications being incorporated by reference herein.

### FIELD OF THE INVENTION

The invention relates to a method for deriving environmental information from detecting the rear lights of preceding vehicles. The environmental information can in particular be made available to driver assistance systems.

Within the scope of this invention, rear vehicle lights or lamps include the following lamps installed on the vehicle: Back-up light, tail light, brake light, and rear fog light.

### BACKGROUND OF THE INVENTION

Detecting rear lights of preceding vehicles is not the subject matter of this invention. In particular, driver assistance functions for the automatic control of the low beam/high beam setting of the head lamp use the information about detected rear lights of vehicles for controlling the high beam light to prevent drivers of preceding vehicles from being blinded. An example of this driver assistance function is shown in EP 2057583 B1, which is incorporated by reference.

Another example is the detection of brake light activation. EP 1851681 B1, which is incorporate by reference, shows a method for detecting the activation of brake lights of preceding vehicles in which a vehicle moving in front is captured using an image sensor, and if lighting of its brake lights is detected, a signal is output that can be translated in a warning system and/or in a driver assistance system.

It is concluded from the brake light activation that the preceding vehicle is performing a braking operation.

### SUMMARY OF THE INVENTION

An aspect of the invention provides additional or improved information about the vehicle surroundings for the most varied driver assistance functions by detecting the rear vehicle lights.

This is achieved, according to an aspect of the invention, by analyzing the position and movement of the rear lights of preceding vehicles, which are identified and tracked in a sequence of images. The image sequence is recorded using a camera that captures the surroundings in front of the vehicle. The desired environmental information is derived from this analysis.

The invention is based on the consideration that information can be derived from the behavior of preceding vehicles. Preceding vehicles are identified by the lights installed on their rear. Light information which, for example, a high beam assistance system can provide can in this way be used for deriving other environmental information.

The position and movement of rear lights also allow conclusions about the vehicle behavior. In turn, the vehicle behavior implicitly allows inferences with respect to the environment. Assuming that the rear lights belong to a preceding vehicle, a number of assumptions can be made:

These include, for example:
The preceding vehicle typically is on the same road
The preceding vehicle cannot behave arbitrarily but only in a way that makes physical sense
The height of the rear lights above the road is within a limited range of values.
   Another characteristic is that this information refers to sections of the road ahead and thus allows a forecast.

In principle, it is possible to analyze single rear lights. It should be considered though that two-wheeled vehicles are subject to lesser physical constraints than vehicles with three or four wheels.

Alternatively, the analysis may focus on pairs of lights only that can be assigned to a vehicle. For the latter assumption, it is plausible that the connecting line of the two rear lights is substantially parallel to the road surface.

The invention has the following technological advantages:

Information derived from the rear lights of preceding vehicles is robust and can be reliably obtained, especially in the dark and in conditions of poor visibility. For example, camera-based lane detection may not work, or only to a limited degree in such conditions, when the road markings can no longer clearly be seen. But rear lights of preceding vehicles are activated and can be identified in poor visibility and in the dark, and they can be used to estimate the position of the lane ahead.

Values for detected and tracked rear lights can be made available, e.g. by a high beam light assistant installed in the vehicle.

A considerable amount of a priori knowledge can be utilized using the light information. The derived information refers to events or sections of the road that are still ahead of the vehicle.

The invention further relates to a device comprising a camera and means for deriving environmental information from detecting the rear lights of preceding vehicles.

Other advantageous modifications of the invention can be found in the dependent claims and the in the embodiments described.

### DETAILED DESCRIPTION OF THE INVENTION

The invention will be explained below with reference to embodiments.

The following environmental information can also be obtained:

a) A (sharp) bend of the road can be derived from a lateral movement (specific pattern of movement) of one or several pairs of lights.

The following pattern of movement can be identified: The lights of preceding vehicles show little movement in the image on straight sections of the road. But if the preceding vehicle passes through a bend while the vehicle with the camera is still in the straight section of the road, the lights of the preceding vehicle make an accelerated movement to the side. One vehicle alone is sufficient to conclude that there is a bend in the road. If there are several vehicles, these support the hypothesis and increase the accuracy of the estimate of the distance to the bend.

b) A turn to the left or right can be derived from a lateral movement (specific pattern of movement, see case a)) of one or several pairs of lights. Information about activated blinkers can be used to distinguish this behavior from case a).

c) Bumps in the road, upward or downward slopes can be derived from vertical movement of one or several pairs of lights.

d) Information about heavy traffic or traffic jams can be derived from the density of rear lights ahead.

e) When driving in convoy, braking phases can be derived from the frequent occurrence of sudden increases in brightness.

f) Fog or extremely poor visibility can be derived if the rear fog lights of a preceding vehicle are detected. The position of the lane ahead can be estimated from the movement of the detected rear fog lights to support lateral control and keep the vehicle in lane (especially on freeways).

g) A braking maneuver of the preceding driver can be derived from a sudden increase in brightness of the red rear lights.

The environmental information derived can be used, for example, by the following driver assistant functions:

a) Sharp bend warning (from lateral movement)

b) Bending light mode (from lateral movement)

c) Recommended course of the road (from lateral movement)

d) Overtaking assistant (from lateral and vertical movement, not recommended if rear fog lights are detected)

e) Chassis conditioning for bumps (from vertical movement)

f) Traffic routing assistance (from density)

g) Brake preconditioning if a collision is imminent

h) Rear-end collision warning if a collision is imminent

i) PreCrash information

j) Emergency brake assist

k) Emergency steer assist

1. A method for deriving environmental information from detecting rear lights of preceding vehicles, comprising the following steps:
recording a sequence of images with a camera that captures surroundings in front of the vehicle;
detecting and tracking the rear lights of preceding vehicles in a sequence of images; and
analyzing position and movement of the tracked rear lights and deriving environmental information from this analysis.

2. The method according to claim 1, wherein at least a possible course of the road is derived as environmental information from the tracked rear lights.

3. The method according to claim 1, wherein an additional analysis of the number of tracked rear lights is performed and at least a high density of preceding vehicles and/or driving in convoy are derived as environmental information from the tracked rear lights.

4. The method according to claim 1, wherein an additional analysis of the intensity of the tracked red rear lights is performed and environmental information with respect to braking operations of preceding vehicles and/or fog are derived from the tracked rear lights.

5. The method according to claim 3, wherein a collective braking phase is derived from the frequent occurrence of sudden increases in intensity of the tracked red rear lights if driving in convoy is detected.

6. The method according to claim 1, wherein a bending or branching of the road is derived from a lateral movement of the tracked rear lights.

7. The method according to claim 1, wherein a bump, upward or downward slope of the road is derived from a horizontal movement of the tracked rear lights.

8. The method according to claim 1, wherein the detection of the rear lights from a sequence of images is performed by a method for automatic light control or a high beam light assistance system.

9. A device for deriving environmental information from detecting the rear lights of preceding vehicles, comprising:
a camera that captures the surroundings in front of the vehicle and records a sequence of images;
a first processing means for detecting and tracking rear lights of preceding vehicles in the sequence of images;
a second processing means for analyzing the position and movement of the tracked rear lights and for deriving environmental information from this analysis;
a data transmission unit via which the derived environmental information can be transmitted.
